(19) United States
(12) Patent Application Publication
(10) Pub. No.: US 2009/0200692 A1
(43) Pub. Date: Aug. 13, 2009

(54) Method for manufacturing a silicone contact lens having a hydrophilic surface

(76) Inventor: Jame Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,465

(22) Filed: Feb. 7, 2008

(51) Int. Cl. B29D 11/00; G02B 1/12

(52) U.S. Cl. 264/1.38

(57) ABSTRACT

A method for manufacturing a silicon hydrogel gel contact lens having a hydrophilic surface is provided, whereby a hydrophilic biomedical material such as, HEMA, GMA, GMMA, NVP, MAA, MMA, PVA, PU, HA, collagen, chitosan, polydextrose, etc. is combined with a surface of a soft silicone gel or a silicone hydrogel material to form a sandwiched structure of a body of a contact lens. With this method, the surface of the soft silicone gel or the silicone hydrogel material can be completely coated with the hydrophilic biomedical material, so that a hydrophobic silicone dry spot on the surface resulting from a hydrophobic silicone component in the soft silicone gel or silicone hydrogel material is completely coated. Thus, a contact lens having a completely hydrophilic surface and a high oxygen-permeability is formed, which can be more comfortably worn for a longer time. Particularly, the concise manufacturing method of the prevention can be combined with existing manufacturing equipment to mass-produce hydrophilic contact lenses with a high oxygen-permeability at a lower cost.

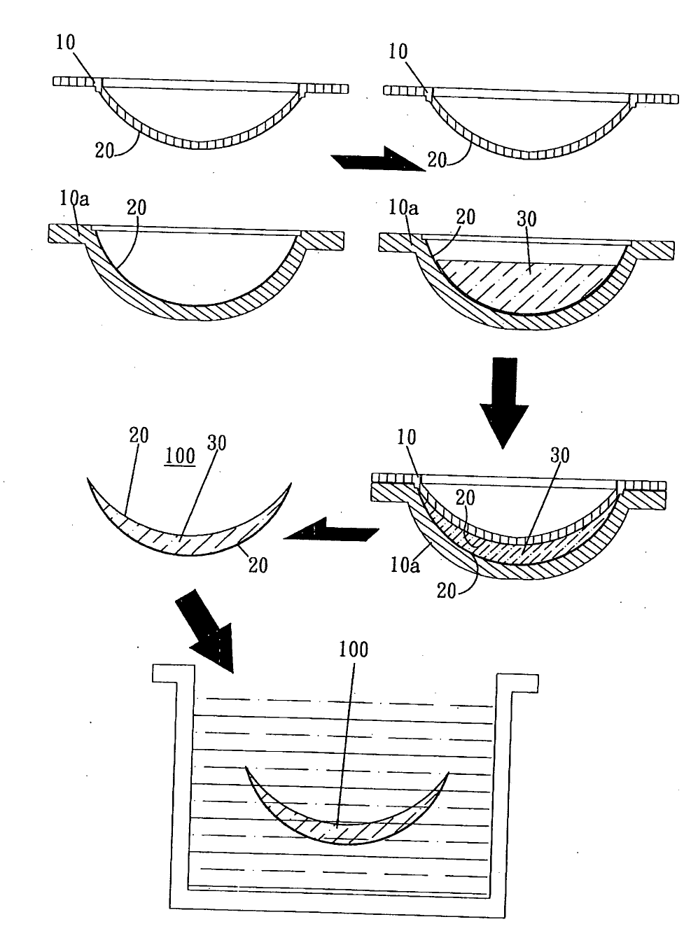

### BACKGROUND OF THE INVENTION

1. Technical Field

The present invention relates to a method for manufacturing silicone contact lenses with sandwich structure.

2. Description of Related Art

Contact lenses have been commoditized for over 60 years since their invention in the beginning—1950's. The earliest contact lenses were made of such as poly methyl methacrylate (PMMA) to form a hard lens. And because of the hard material as well as a low oxygen-permeability and poor hydrophilicity of the lens body, those contact lenses could only be worn for a short time and might cause an uncomfortable sensation due to its obvious presence as a foreign body in the eye.

In the early—1970's, an advantageous improvement was made in the art of contact lenses with the invention of soft contact lenses, which are made of a acrylic hydrogel material composed mainly of 2-hydroxy ethyl methacrylate (HEMA). When hydrated, these highly water-absorbing contact lenses become soft and have a feature of low-mid water contents, so that the wearing comfort is increased. Though later inventors had tried to increase water content to increase oxygen-permeability by add in chemical such as polyvinyl alcohol, methyl methacrylic acid . . . etc however, these soft contact lenses are still low in oxygen-permeability and can only be worn for eight to twelve hours a day. A prolonged use of the HEMA soft contact lenses often leads to such lesions as corneal edema and neovascularization due to hypoxia.

The high oxygen permeability, 10 times more than HEMA, of the silicone material had been well acknowledged for a while. In early 1980's, rigid gas permeable (RGP) contact lenses contents silicone material with a benefit of high oxygen-permeability were developed. While human cornea is a hydrophilic surface for exchanging tear film, oxygen, carbon oxide, ion and metabolisms of eyes, the hydrophobic surface of RGP silicone lenses causes discomfort easily when worn on the hydrophilic corneas. Also the uncomfortable feeling of foreign body sensation in the eyes resulted from the rigid hydrophobic silicone material of the lenses still cannot be improved. To solve this issue, another approach is to increase the hydrophilic of silicone material by modifying the chemical structure of silicone gel, compounding the silicone polymer with hydrophilic monomers, to form a semi-rigid lens material. But the foreign body sensation still can't be solved. As a result, these rigid contact lenses are not widely accepted by consumers.

As can be known from the above, lenses with high oxygen-permeability, increased comfort and extended wearing time are what consumers have always demanded for vision correction. After continuous improvement in the contact lens industry, a highly oxygen-permeable, soft silicone gel with partial hydrophilic feature and silicone hydrogel has become a main stream in the development of contact lens.

Soft silicone gel is comprising by hydrophilic acrylic functional group and by silicone material which is an unstable, hydrophobic component. Therefore contact lenses made of a soft silicone gel tend to have a large number of hydrophobic silicone dry spots on lens surface, thereon, such that a user wearing the lens may feel uncomfortable in the eye despite their high oxygen-permeability. To enhance the comfort of wearing contact lenses made of a soft silicone gel, the industry has worked incessantly on ways of improvement and finally came up with methods to increase the hydrophilicity of contact lenses made of soft silicone gel or silicone hydrogel while maintaining the lenses' high oxygen-permeability; one of method is, through plasma treatment, bonding a hydrophilic material such as, for example, HEMA, glycerol methacrylate (GMA), glycerol methyl methacrylate (GMMA), N-vinyl pyrrolidone (NVP), methacrylic acid (MAA), methyl methacrylate (MMA), poly vinyl alcohol (PVA) and the like on the surface of a silicone contact lens.

However, the above-mentioned method incurs a high facility cost and involves complicated procedures. During the manufacturing process, the quality of the bonding hydrophilic material on the surface of a contact lens made of soft silicone gel or silicone hydrogel is highly unstable, which leads to the hydrophilic surface be a highly fraction defective and to be peeled off easily, so that the manufacturing cost cannot be reduced.

Another method begins with forming macromers of silicone polymer and hydrophilic monomers as main material with which to polymerize a silicone hydrogel contact lens, wherein the macromer has such major components as highly oxygen-permeable and hydrophilic features. For example TRIS (trimethyl siloxysilane) gel and or fluorinated TRIS gel, and is further combined with polyurethane and hydrophilic biomedical material such as, HEMA, GMA, GMMA, NVP, MAA, MMA, . . . etc. to increase the wettability and water-contenting to enhance the wearing comfort of silicone hydrogel contact lenses.

To synthesis such a silicon hydrogel macromer is a very complicated manufacturing process. Furthermore, not only the macromer has an extremely high manufacturing cost, but its quality and purity are difficult to control during the process of contact lenses manufacturing. Moreover, the macromer also contains the unstable component of silicone gel, such that a polymerization of silicone gel with hydrogel is merely a combination of different material properties, namely, hydrophobic and hydrophilic, whose advantages are utilized respectively. The difficulty of the synthesis process is something like to mix water and oil homogeneously. Moreover while the hydrophilic feature of the silicone hydrogel contact lenses is improved, the unstable property of silicone still results in a large number of hydrophobic silicone dry spots on the surfaces of the contact lenses. The uncomfortable sensation associated with the low wettability of silicone hydrogel contact lenses still cannot be eliminated.

In view of the above-mentioned shortcomings and based on years of experience in the industry, the inventor of the present invention has deliberated on ways of improvement, with the aims of providing a contact lens with high oxygen-permeability and high hydrophilic surface just like a sandwiched structure, so as to increase the wearing time and comfort of contact lenses. After painstaking research and numerous experiments, a method for manufacturing a contact lens of a silicone material having a hydrophilic surface is finally obtained and disclosed herein.

### SUMMARY OF THE INVENTION

The present invention provides a method for manufacturing a silicone contact lens having a hydrophilic surface, whereby a hydrophilic biomedical material is combined with a surface of a soft silicone gel or a silicone hydrogel material to form a sandwiched structure of a body of a contact lens. With this method, a surface of a soft silicone gel or a silicone hydrogel material can be completely coated with a hydrophilic biomedical material, so that a hydrophobic silicone dry spots on the surface resulting from a hydrophobic silicone component in the soft silicone gel or silicone hydrogel material is completely coated. Thus, a contact lens having a completely hydrophilic surface and a high oxygen-permeability is formed, which can be more comfortably worn for a longer time.

Particularly, the concise manufacturing method of the prevention can be combined with existing contact lens manufacturing facilities and molds to mass-produce hydrophilic contact lenses which having feature of high oxygen-permeability, wherein the method of the present invention is integrated with known a manufacture processes of cast molding.

### BRIEF DESCRIPTION OF THE DRAWINGS

The objectives, processes and spirits of the present invention can be completely understood by viewing the following description in conjunction with the accompanying drawings, wherein:

The FIGURE is a schematic drawing of a method for manufacturing a soft silicone gel or a silicone hydrogel contact lens having a hydrophilic surface according to a first embodiment of the present invention; and

### DETAILED DESCRIPTION OF THE PREFERRED EMBODIMENT

Referring to the FIGURE, a method for manufacturing a soft silicone gel or a silicone hydrogel contact lens having a hydrophilic surface according to a first embodiment of the present invention comprises the following steps.

Step 1: Coating a male mold 10 and a female mold 10a of a cast mold on respective surfaces thereof with a film of a hydrophilic biomedical material 20, and using ultra-violet radiation and/or a heat source equipment to do semi-cure the film of the hydrophilic biomedical material 20, wherein the hydrophilic biomedical material 20 coated on the respective surfaces of the male mold 10 and the female mold 10a has a thickness of about 0.1 to 10 micron, and the film of the hydrophilic biomedical material 20 can be evenly coated on the respective surfaces of the male mold 10 and the female mold 10a by printing, spray printing, inkjet printing, pad transfer printing, spin printing, ultra-sonic printing and the like, while the hydrophilic biomedical material 20 can be pre-mixed or pre-polymerized with other materials such as, dyes, pigments, anti-UV material, opaque cosmetic pigments, opaque cosmetic dyes and the like, according to desired functions of the contact lens, in which the hydrophilic biomedical material 20 is added with cross-linking agents and initiators for the chemical reaction between the functional groups of the surface hydrophilic biomaterial and the soft silicone material of lens body.

Step 2: Filling a main lens raw material 30 into the female mold 10a which is coated on the surface thereof with the film of the hydrophilic biomedical material 20, then pressing onto the female mold 10a the male mold 10 which is coated on the surface thereof with the film of the hydrophilic biomedical material 20, and then using the ultra-violet radiation and/or the heat source equipment to bond the semi-cured films of the hydrophilic biomedical material 20 on the respective surfaces of the male mold 10 and the female mold 10a with the main lens raw material 30 and cure the same to form an optical shape design, thereby forming an optical lens; and

Step 3: Releasing the lens that has been cast molded to shape from the mold, and putting the same into a normal saline and/or a organic solvent tank for hydration, expansion and extraction, so as to form a contact lens 100 having a sandwiched structure, a high oxygen-permeability lens body and a high hydrophilic surface, wherein the main lens raw material 30 can be soft silicone gels, or macromers of silicone hydrogel.

In summary, the method according to the present invention serves the predetermined functions, is not seen in public use, and meets the requirements of usefulness and novelty for patent application. A patent application of the present invention is therefore filed for examination.

It should be noted that, the above description of the present invention is based on preferred embodiments thereof and alterations can be made according to the concept of the present invention. All such alterations are encompassed by the appended Claims provided that functions and effects of these alterations do not depart from the scope and spirit of the present invention disclosed in this specification and the accompanying drawings.

What is claimed is:

1. A method for manufacturing a soft silicone gel contact lens and a silicone hydrogel contact lens having a hydrophilic surface comprising steps of:
Step 1: coating a male mold and a female mold of a cast mold on respective surfaces thereof with a film of a hydrophilic biomedical material, and using ultra-violet radiation and/or heat source equipment to do semi-cure the hydrophilic biomedical material film;
Step 2: filling a main lens raw material into the female mold which is coated on the surface thereof with the hydrophilic biomedical material film, then pressing onto the female mold the male mold which is coated on the surface thereof with the hydrophilic biomedical material film, and then using the ultra-violet radiation and/or the heat source equipment to do curing to bond the hydrophilic biomedical material films on the respective surfaces of the male mold and the female mold with the main lens raw material and cure the same to a design shape, thereby forming an optical lens; and
Step 3: releasing the lens that has been cast molded to shape from the mold, and putting the lens into a normal saline and or organic solvent liquid tank for hydration, expansion and extraction, so as to form a contact lens having a sandwiched structure, a high oxygen-permeability body and a high hydrophilic surface.

2. The method as claimed in claim 1, wherein the hydrophilic biomedical material can be, 2-hydroxy ethyl methacrylate (HEMA), glycerol methacrylate (GMA), glycerol methyl methacrylate (GMMA), N-vinyl pyrrolidone (NVP), methacrylic acid (MAA), methyl methacrylate (MMA), polyurethane (PU), poly vinyl alcohol (PVA), hyaluronic acid (HA), collagen, chitosan, polydextrose or the like.

3. The method as claimed in claim 1, wherein the hydrophilic biomedical material can be pre-mixed or pre-polymerized with coloring material, dyes such as Blue-19, pigments such as Blue-15 and iron oxide, anti-UV material such as hydroxyphenoxy ethylacrylate, opaque cosmetic pigments such as TiO2 with pigment, opaque cosmetic dyes such as TiO2 with dyes or the like, according to desired functions of the contact lens.

4. The method as claimed in claim 1, wherein the hydrophilic biomedical material film is evenly coated on the respective surfaces of the male mold and the female mold by printing, spray printing, ink-jet printing, pad transfer printing, spin printing, ultra-sonic printing or the like.

5. The method as claimed in claim 4, wherein the hydrophilic biomedical material film has a thickness of about 0.1 to 10 micron, and preferably about 0.5 to 2 micron.

6. The method as claimed in claim 1, wherein the main lens raw material is soft silicone gels, or macromer of silicone gel and hydrogel. Both which with the function groups for chemical reaction to bond the hydrophilic biomaterial and the silicone hydrogel material tightly when do cure.

7. The method as claimed in claim 1, wherein the hydrophilic biomedical material is added with cross-linking agents such as trimethylol propane trimethacrylate (TMPTMA), Ethylene glycol dimethacrylate (EDGMA) and initiators such as 2-Hydroxy-2-methyl-1-phenyl-propan-1-one (Ciba® DAROCUR® 1173), azobisisobutyronitrile (AIBN), and the like.

8. The method as claimed in claim 1, wherein the hydrophilic biomedical material is pre-mixed or pre-polymerized with dyes or pigments to produce tint or opaque cosmetic colors.

9. The method as claimed in claim 1, wherein the hydrophilic biomedical material is pre-mixed or pre-polymerized with anti-UV material.

10. The method as claimed in claim 1, wherein the hydrophilic biomedical material is pre-mixed or pre-polymerized with dyes, pigments and anti-UV materials.

11. The method as claimed in claim 1, wherein the hydrophilic biomedical material is pre-mixed or pre-polymerized with opaque cosmetic pigments, opaque cosmetic dyes and anti-UV materials.
